(19) United States
(12) Patent Application Publication
(10) Pub. No.: US 2023/0269663 A1
(43) Pub. Date: Aug. 24, 2023

(54) LOW-POWER WIRELESS NETWORK SYSTEM

(71) Applicant: LS ELECTRIC CO., LTD., Anyang-si, Gyeonggi-do (KR)

(72) Inventors: Seongjoon LEE, Anyang-si, Gyeonggi-do (KR); Jeongyeup PAEK, Anyang-si, Gyeonggi-do (KR)

(21) Appl. No.: 17/921,496

(22) PCT Filed: Mar. 29, 2021
(86) PCT No.: PCT/KR2021/003815

§ 371 Date: Oct. 26, 2022

(30) Foreign Application Priority Data
Apr. 28, 2020 (KR) 10-2020-0051610

(51) Int. Cl. H04W 52/02; H04W 48/20

(52) U.S. Cl. CPC H04W 52/0206; H04W 48/20

(57) ABSTRACT

The present disclosure provides a low-power wireless network system comprising: a manager node; nodes for transmitting data collected through a tag area network; and a sink node (base station) which is selected by a command of the manager node and transmits the data transmitted from the nodes to the manager node, wherein the sink node individually performs communication with the nodes and receives the data, on the basis of a wakeup interval configured for each of the nodes.

### CROSS-REFERENCE TO RELATED APPLICATIONS

This application is the National Stage filing under 35 U.S.C. 371 of International Application No. PCT/KR2021/003815, filed on Mar. 29, 2021, which claims the benefit of earlier filing date and right of priority to Korean Application No. 10-2020-0051610, filed on Apr. 28, 2020, the contents of which are all hereby incorporated by reference herein in their entirety.

### FIELD

The present disclosure relates to a low-power wireless network system, and more particularly, to a low-power wireless network system in which energy efficiency for each of nodes using various power sources is enhanced and setting or unsetting of routes of new nodes to be added is facilitated.

### BACKGROUND

As wireless sensor network technology advances, various Internet of things (IoT) services utilizing the wireless sensor network technology are being widely used in a real world.

As representative services, services transceiving commands/responses between smart homes/buildings/cities/grids/factories/power distribution units, etc. to periodically collect sensor data are provided, and various sensors and protocols may be adopted according to purposes of respective services.

However, there are many limitations on the wireless sensor network due to requirements such as “low-power operation.” To resolve these limitations, various methods/technologies, etc. are adopted. For example, technology of connecting communication devices to each other by using a multi-hop method to overcome limitations on a communication distance, radio duty cycling technology of maintaining a radio link to an off state at ordinary times and transitioning the radio link to an on-state only when necessary, etc. are present.

Generally, resources (power or a bandwidth) of communication devices (hereinafter referred to as “nodes”) configured to operate in a low-power wireless network are very limited. Researches on reducing power consumption of the nodes, among the communication devices, include radio duty cycling (RDC)-based low power listening (LPL).

FIG. 1 is a diagram illustrating an operation of a general asynchronous RDC/LPL.

Referring to FIG. 1, the RDC/LPL is configured to minimize power consumption of a node. A main point of RDC technology is to maintain a communication chip in a sleep state at all times to minimize power consumption instead of waking up the communication chip, unless a data packet to be transmitted is present or there is a particular situation in which presence of a data packet to be periodically received needs to be checked. In this case, a receiver may receive the data packet only in a wakeup state.

RDC/LPL technology includes a synchronous method and an asynchronous method. The synchronous method is a method in which time when a receiver transitions to a wakeup state is precisely determined by synchronizing time between nodes, and thus, a data packet is transmitted only at corresponding timing. The asynchronous method is a method in which redundant data is continuously transmitted until a wakeup interval in which the receiver transitions from the sleep state to the wakeup state, without having to time-synchronize with a counterpart.

In the asynchronous method, a transmitter finishes the transmission when the data packet has been transmitted until the wakeup interval, or the transmitter receives an acknowledgment such that the receiver normally received the data packet in a middle of the transmission. The synchronous method and the asynchronous method have advantages and disadvantages, respectively. However, since an exchange of a data packet between nodes does not frequently occur in the general low-power wireless network, the asynchronous method is adopted rather than the synchronous method in which an additional data packet exchange (overhead) for time synchronization is needed.

As described above, since the resources of the nodes are very limited, a transmission strength is also limited. Thus, a problem such as a limitation on a communication distance may be caused.

Accordingly, as a method of overcoming the limitation on the communication distance, a multi-hop routing technique is mainly used. The multi-hop routing technique may be largely divided into a mesh structure and a tree structure.

FIG. 2 is a diagram illustrating a tree structure among a general routing method.

Referring to FIG. 2, in the tree structure, one or more sink nodes (a base station) are present, and respective nodes have a parent-child relationship and transmit data of the respective nodes to a parent node.

A method of explaining a multi-hop method based on the tree structure includes a static method and a dynamic method.

The static method is a method in which whether a node is to be connected to another node in an installation phase is manually set. The static method has an advantage such that an installation may be performed to have a structure that a network manager wants. However, in a case of the static method, maintenance is very difficult, and link quality of a corresponding route may be very poor due to a variable unexpected by the network manager. Thus, the dynamic method in which nodes automatically search for and are connected to routes is mainly used.

In the dynamic method, the nodes may propagate, find, or update efficient routes.

FIG. 3 is a diagram for explaining the dynamic method by using the multi-hop method based on a general tree structure.

Referring to FIG. 3, each of nodes B to F may find a most efficient route to reach a sink node A (a base station) by periodically transmitting a beacon to the sink node A to notify the sink node A of state information.

The periodic transmission of the beacon may have an advantage such that a high-quality route for reaching the sink node A may be found, but has a disadvantage such that additional data transmission is needed.

That is, when a transmission interval is short, state information of the beacon is quickly updated, but power consumption may become excessive. When a transmission period is long, real-time property of the state information is not ensured.

On the other hand, when the periodic transmission of beacons is arbitrarily performed without following a particular schedule, the beacons may collide with each other. In a case of beacon collision, nodes periodically waiting for a beacon may lose synchronization with a sink node of the nodes, and eventually, communication in a network may not be performed.

Recently, researches on facilitating communication between nodes and a sink node in a network are being conducted.

### SUMMARY

Therefore, to obviate those problems, an aspect of the detailed description is to provide a low-power wireless network system in which energy efficiency for each of nodes using various power sources is enhanced and setting or unsetting of routes of new nodes to be added is facilitated.

Another aspect of the detailed description is to provide a low-power wireless network system in which a tag area network which includes a set of nodes connected to one sink node is provided, and the nodes connected to the sink node are easily found, set, or unset.

Objectives of the present disclosure are not limited to the aspects of the detailed description described above, and other objectives and advantages may be understood based on the following description, and clearly based on embodiments of the present disclosure. It may be understood that the objectives and advantages of the present disclosure may be implemented by elements recited in claims and a combination thereof.

To achieve these and other advantages and in accordance with the purpose of the present disclosure, as embodied and broadly described herein, there is provided a low-power wireless network system including: a manager node; nodes configured to transmit data collected via a tag area network; and a sink node which is a base station, selected by a command by the manager node, and configured to transmit the data transmitted from the nodes to the manager node, wherein the sink node individually performs communication with the nodes and receives the data, on a basis of a wakeup interval configured for each of the nodes.

The wakeup interval may be a transition interval of each of the nodes from a sleep state to a wakeup state in which communication may be performed.

When first and second new nodes are installed in the tag area network, the manager node may transmit, to the sink node, a scan command for checking installation of the first and second new nodes.

When the scan command is received, the sink node may transmit a scan packet corresponding to the scan command to the tag area network, and receive first and second route notification packets transmitted from the first and second new nodes, respectively, to check the installation of the first and second new nodes.

When the scan packet is received, the first and second new nodes may set priority routes to the sink node and transmit the first and second route notification packets to the sink node, respectively.

When the installation of the first and second new nodes is checked, the sink node may transmit, to the manager node, a request packet for requesting first and second identifications (IDs) of the first and second new nodes to set routes for communication in the tag area network.

When the request packet is received and only a route of the first new node among the first and second new nodes is set in the tag area network, the manager node may transmit, to the sink node, the first ID and a route set command to set the route of the first new node, and the sink node may set and update the first ID in a set route table according to the route set command, and transmits a route notification set packet to the first new node.

When the route notification set packet is received, the first new node may transmit, to the sink node, a first route set packet for the priority route to notify setting of the priority route.

When the second new node does not receive the route notification set packet for a set time period, the second new node may unset the setting of the priority route.

When the request packet is received and routes of the first and second new nodes are set in the tag area network, the manager node may transmit, to the sink node, the first and second IDs and the route set command to set the routes of the first and second new nodes, and the sink node may set and update the first and second IDs in the set route table according to the route set command.

When the route notification set packet is received, the first and second new nodes may transmit, to the sink node, first and second route setting packets for the priority routes to notify setting of the priority routes, respectively.

When a particular node among the nodes is unset from the tag area network, the manager server may transmit a particular ID of the particular node and an unset command to the sink node to unset the particular node.

The sink node may transmit an unset packet to the particular node according to the unset command, and unset the particular ID from a route table in which IDs of the nodes are set.

When the unsetting packet is received, the particular node may delete a priority route set in the tag area network, and transmit, to the tag area network, a route unset notification packet for notifying the unsetting.

A first node, among the nodes, may transmit a first data packet including a first wakeup interval and the data to at least one of a sink node and a second node among the nodes.

The at least one of the second node and the sink node may set, in a set wakeup table, the first wakeup interval included in the first data packet, and transmit a second data packet to the first node according to the first wakeup interval.

In accordance with the detailed description, a low-power wireless network system according to the present disclosure has an advantage such that a sink node (a base station) may search for (scans) nodes connected to a tag area network according to a command by a manager node and connect at least one node among the nodes to the tag area network to perform communication.

In addition, the low-power wireless network system according to the present disclosure has an advantage such that a data packet including a wakeup interval configured for each of the nodes connected to the tag area network is transmitted so that when a receiver receives the data packet, the receiver transmits the data packet according to the wakeup interval, and thus, power efficiency of each of the nodes is enhanced.

In addition, the low-power wireless network system according to the present disclosure has an advantage such that the sink node may unset a node of which route is set in the tag area network.

In addition to the effects described above, specific effects of the present disclosure will be described together with explanation of the detailed description of the present disclosure.

### BRIEF DESCRIPTION OF THE DRAWINGS

FIG. 1 is a diagram illustrating an operation of a general asynchronous radio duty cycling (RDC)/low power listening (LPL).

FIG. 2 is a diagram illustrating a tree structure among a general routing method.

FIG. 3 is a diagram for explaining a dynamic method by using a multi-hop method based on a general tree structure.

FIG. 4 is a diagram schematically illustrating a low-power wireless network system according to the present disclosure.

FIG. 5 is a diagram briefly illustrating a data packet transceived in the low-power wireless network system according to the present disclosure.

FIGS. 6 to 8 are conceptual diagrams illustrating an operation of a sink node of FIG. 4.

FIG. 9 is a conceptual diagram illustrating a state change of a node of FIG. 4.

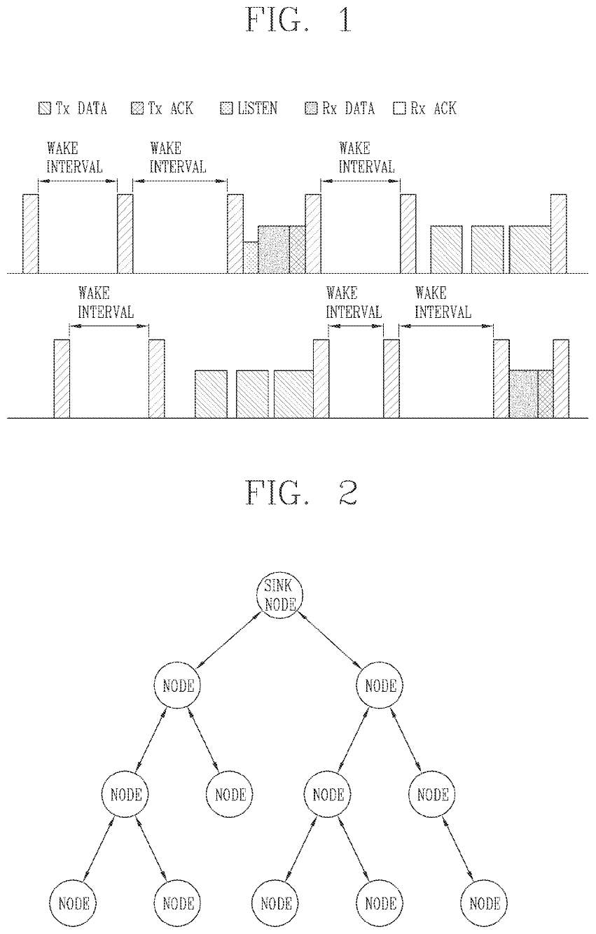

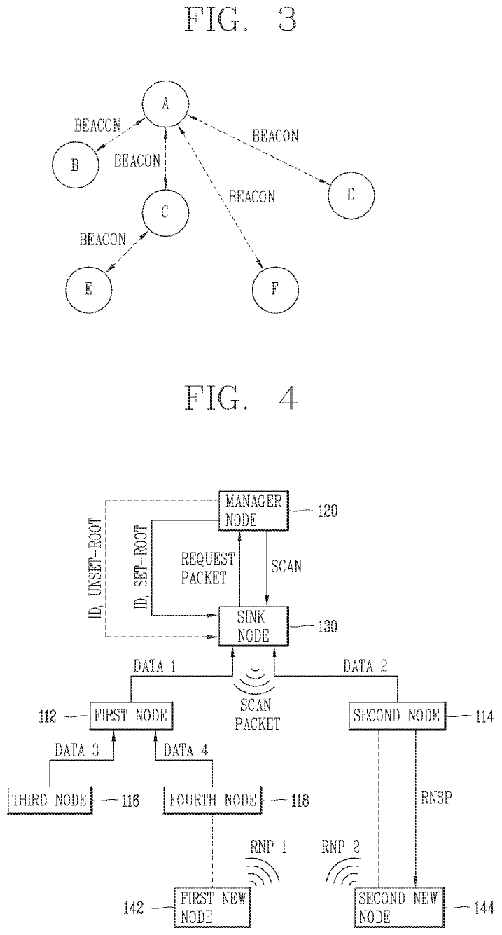

### DETAILED DESCRIPTION

It should be noted that only the explanations needed for better understanding of embodiments of the present disclosure are provided in the following description, and other explanations may be omitted when it is deemed that they may unnecessarily obscure the essence of the present disclosure.

Hereinafter, terms or words used in this specification and claims should not be interpreted as being limited to have a general meaning or a meaning defined in a dictionary, but should be interpreted as having a meaning and a concept which are consistent with the technical ideas of the present disclosure, based on a principle such that an inventor may properly define concepts of the terms to explain the disclosure of the inventor by using an optimum method. Accordingly, it should be understood that embodiments in the specifications and configurations illustrated in drawings are only example embodiments, and there is no intent to limit the example embodiments to the particular forms disclosed, but on the contrary, example embodiments are to cover all modifications, equivalents, and alternatives falling within the scope of the present disclosure.

Hereinafter, embodiments of the present disclosure will be described in detail with reference to the accompanying drawings.

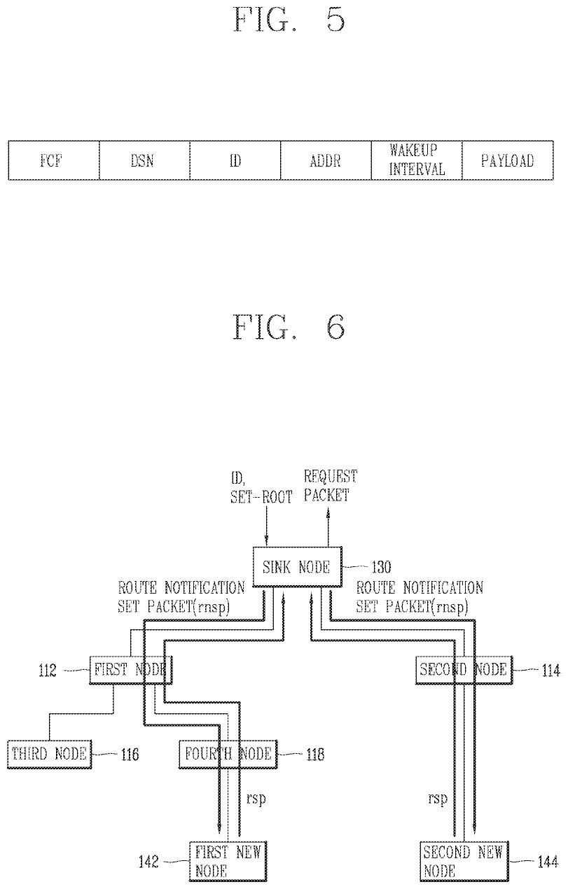

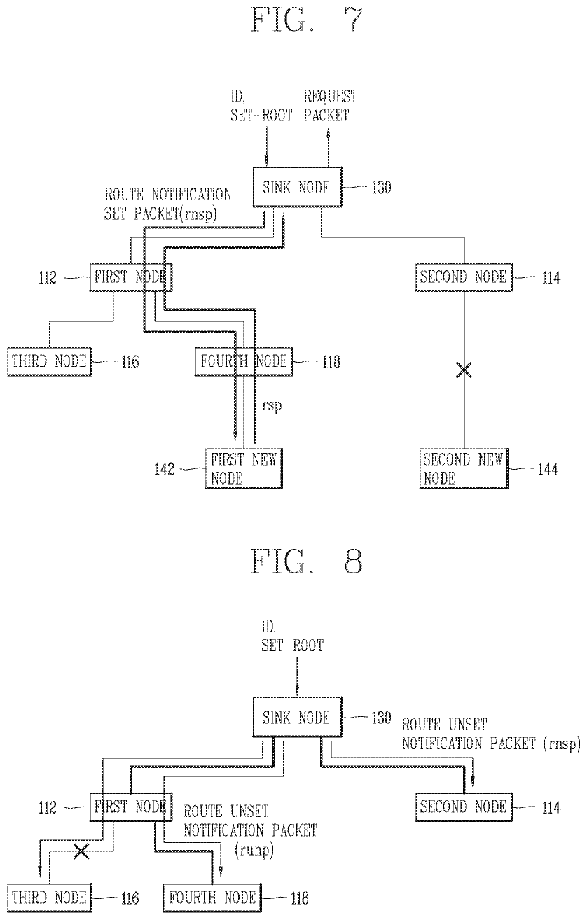

FIG. 4 is a system diagram schematically illustrating a low-power wireless network system 100 according to the present disclosure. FIG. 5 is a diagram briefly illustrating a data packet transceived in the low-power wireless network system 100 according to the present disclosure. FIGS. 6 to 8 are conceptual diagrams illustrating an operation of a sink node 130 of FIG. 4.

Referring to FIGS. 4 to 8, the low-power wireless network system 100 may include first to fourth nodes 112, 114, 116, and 118, a manager node 120, and the sink node 130.

Each of the first to fourth nodes 112, 114, 116, and 118 may be a communication device that may perform communication, an Internet of things (IoT) sensor, or the like, but is not limited thereto.

In the embodiments, four nodes including the first to fourth nodes 112, 114, 116, and 118 are described. However, a number of nodes is not limited.

The first to fourth nodes 112, 114, 116, and 118 may transmit, to the sink node 130, first to fourth data packets DATA 1 to DATA 4 including collected data.

Here, the first to fourth data packets DATA 1 to DATA 4 may include a wakeup interval configured for each of the first to fourth nodes 112, 114, 116, and 118.

The wakeup interval indicates a transition interval at which each of the first to fourth nodes 112, 114, 116, and 118 transitions from a sleep state to a wakeup state in which communication may be performed. When the receiver receives a data packet, the receiver may transmit the data packet according to the wakeup interval. Thus, power may be efficiently used.

In the embodiments, the first to second nodes 112 and 114 are connected to the sink node 130, and the third to fourth nodes 116 and 118 may be connected to the first node 112 via a route.

Here, routes in which the third to fourth nodes 116 and 118 transmit the third and fourth data packets DATA 3 and DATA 4, respectively, to the sink node 130 via the first node 112 may be set.

A data packet shown in FIG. 5, that is, each of the first to fourth data packets DATA 1 to DATA 4 may include a frame control field FCF, a data sequence number field DSN, a node identification (ID) field ID, an address information field ADDR, a wakeup interval field WAKEUP INTERVAL, and a transmission data field PAYLOAD.

Here, the frame control field FCF is a field indicating a type of a transmitted frame. The data sequence number field DSN is a field indicating a sequence of transmitted data. The node ID field ID indicates an ID of a node transmitting the data. The address information field ADDR is a field for specifying a format of an address field. The wakeup interval field WAKEUP INTERVAL is a field providing a wakeup interval of a transmitter to a reception node configured to receive data. The transmission data field PAYLOAD may indicate a field in which data is loaded.

Here, as the wakeup interval field WAKEUP INTERVAL includes a wakeup interval at which data is transceived, a node configured to transmit the data may check a wakeup interval of a node configured to receive the data. Thus, power consumption during the transmission of the data may be reduced.

The first node 112 may be connected to the third and fourth nodes 116 and 118 in a parent-child relationship. Here, the first to fourth nodes 112, 114, 116, and 118 may have a same network hierarchical structure, but are not limited thereto.

For example, the network hierarchical structure may include an application layer, a network layer, and a link layer.

The application layer may transmit, to the sink node 130, a data packet including data collected according to a control command (a control packet) by the sink node 130.

In addition, the application layer may control a setting of a node and report a state according to the control command (the control packet).

The network layer may be in charge of routing, forwarding, queuing, and multicasting, and be connected to the sink node 130 and gather information about other nodes. In addition, the network layer may transmit a data packet, a control packet, a network plan packet, etc., and perform multiplexing via the link layer.

The link layer may provide a basic link function which is a mechatronic technology such as carrier sense multiple access with collision avoidance (CSMA/CA), acknowledgment (ACK), retransmission, etc. and an RDC function.

Each of the first to fourth nodes 112, 114, 116, and 118 may transmit a data packet according to proper RDC setting by using various state information such as routing information, a power environment, a wakeup interval of a receiver, etc., and use basic CSMA/CA to prevent collision and interference.

Here, the sink node 130 may have a same network hierarchy structure as that of the first to fourth nodes 112, 114, 116, and 118. However, the application layer of the sink node 130 does not operate as a unique application, but interprets a command corresponding to a data packet transmitted from the manager node 110 or a gateway and understands a transmission condition, and then, transmit the data packet to the first to fourth nodes 112, 114, 116, and 118.

The manager node 120 is a communication device used by a manager, and may be configured to set information about the first to fourth nodes 112, 114, 116, and 118 and select the sink node 130 when a tag area network is provided.

In the embodiments, the sink node 130 is provided as a node selected according to a command by the manager node 120.

A case when first and second new nodes 142 and 144 are newly installed in positions of the first to second nodes 112 and 114 in the tag area network including the first to fourth nodes 112, 114, 116, and 118 and the sink node 130 is described below.

When the first and second new nodes 142 and 144 are installed in the tag area network, the manager node 120 may transmit, to the sink node 130, a scan command for searching for the first and second new nodes 142 and 144.

When a request packet for route setting is received from the sink node 130, the manager node 120 may transmit, to the sink node 130, an ID and a route set command (set-root) with respect to at least one new node of the first and second new nodes 142 and 144 of which routes are to be set in the tag area network.

In addition, when the third node 116 among the first to fourth nodes 112, 114, 116, and 118 connected to the tag area network is unset, the manager node 120 may transmit, to the sink node 130, an ID of the third node 116 and an unset command (unset-root) for unsetting the third node 116.

As such, the manager node 120 may select the sink node 130 and, control the selected sink node 130 to search for, set, or unset a node to perform route setting of nodes.

As described above, when the scan command is transmitted from the manager node 120, the sink node 130 may transmit, to the tag area network, a scan packet corresponding to the scan command to search for (to check for installation of) the first and second new nodes 142 and 144.

In this case, the sink node 130 may transmit the scan packet via a wired or wireless communication, but a method of transmitting the scan packet is not limited thereto.

When the scan packet is received, the first and second new nodes 142 and 144 may set a priority route to the sink node 130, and then, transmit first and second route notification packets RNP 1 and RNP 2 to the sink node 130, respectively.

When the first and second route notification packets RNP 1 and RNP 2 are received from the first and second new nodes 142 and 144, respectively, the sink node 130 may transmit a request packet to the manager mode 120 to set a route for each of the first and second new nodes 142 and 144.

As illustrated in FIG. 6, when an ID and a route set command (set-root) with respect to at least one new node among the first and second new nodes 142 and 144 is received from the manager node 120, the sink node 130 may set and update the ID of the at last one new node among the first and second new nodes 142 and 144 in a set route table, and transmit a route notification set packet rnsp to the at last one new node among the first and second new nodes 142 and 144.

Upon reception of the route notification set packet rnsp, the at last one new node among the first and second new nodes 142 and 144 may transmit, to the sink node 130, a route set packet rsp for the priority route to notify setting of the priority route.

When the route set packet rsp for the priority route is received, the sink node 130 may communicate with the first to fourth nodes 112, 114, 116, and 118 and the at least one new node among the first and second new nodes 142 and 144.

Here, a case when the manager node 120 sets only a route of the first new node 142 among the first and second new nodes 142 and 144 in the tag area network, unlike FIG. 6, is described with reference to FIG. 7.

Referring to FIG. 7, the sink node 130 may transmit a request packet to the manager mode 120 to set the routes of the first and second new nodes 142 and 144.

When the sink node 130 receives an ID of the first new node 142 and a route set command (set-root), the sink node 130 may set and update the ID of the first new node 142 in the set route table and may transmit the route notification set packet rnsp to the first new node 142.

In this case, when the route notification set packet rnsp is not transmitted from the sink node 130 to the second new node 144 for a set time period, the second new node 144 may unset the set priority route.

In addition, when the first new node 142 receives the route notification set packet rnsp, the first new node 142 may transmit, to the sink node 130, the route set packet rsp for the priority route to notify setting of the priority route.

When the sink node 130 receives the route set packet rsp for the priority route, the sink node 130 may communicate with the first to fourth nodes 112, 114, 116, and 118 and the first new node 142.

In addition, among the first to fourth nodes 112, 114, 116, and 118 included and route-set in the tag area network, a case when a route with respect to the third node 116 is unset is described.

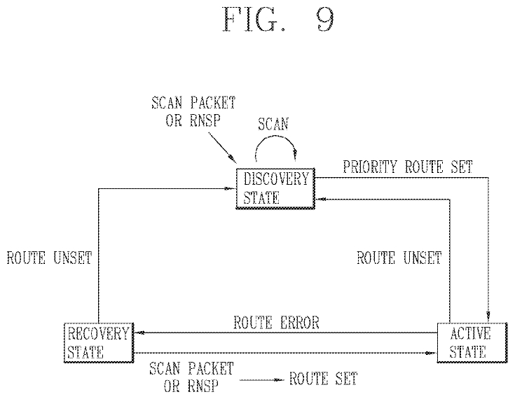

As illustrated in FIG. 8, the sink node 130 may receive, from the manager node 120, the ID of the third node 116 and an unset command (unset-root) for unsetting the third node 116. FIG. 7 illustrates that the first to fourth nodes 112, 114, 116, and 118 and the sink node 130 constitute one tag area network.

In this case, according to the unset command (unset-root), the sink node 130 may transmit an unset packet to the third node 116, and unset the ID of the third node 116 from the set route table in which the IDs of the first, second, and fourth nodes 112, 114, and 118 are set.

Here, when the third node 116 receive the unset packet, the third node 116 deletes the set priority route and transmits, to the tag area network, a route unset notification packet runp for notifying route unsetting, so that the first, second, and fourth nodes 112, 114, 118 the sink node 130 recognize the unsetting.

In addition, the third node 116 may not transmit the route unset notification packet runp.

As described above, the sink node 130 may be selected by the manager node 120, and search for, set, or unset nodes.

FIG. 9 is a conceptual diagram illustrating a state change of a node of FIG. 4

FIG. 9 illustrates a recovery mode for solving a communication problem in a tag area network.

Referring to FIG. 9, a state of the node may be classified into a discovery state, an active state, and a recovery state.

When the node is powered on, the node is in the discovery state. When the node is in the discovery state, the node may be in a state in which the node does not have routing information about peripheral nodes and a sink node.

In the discovery state, the node may receive the scan packet and the route notification set packet rnsp, each transmitted from a certain sink node.

When the node receives the scan packet and the route notification set packet rnsp, the node may update routing information (setting of a priority route), and then, transition to the active state.

When the node is in the active state, the node may ignore a data packet received from another node that does not belong to the tag area network of the node, and receive a control command only via the set route.

In such a case that the node is in the active state, when a malfunction or replacement of a parent node (or the sink node) of the node occurs and the node has not received a routing beacon for 10 minutes, the node may transition to the recovery state.

Like in the discovery node, the node in the recovery state may receive a scan packet and the route notification set packet rnsp both transmitted from all sink nodes.

When the node receives the unset packet in the recovery state, the node may set route setting with respect to a new sink node and transition back to the active state.

However, when an existing route is recovered, and the node receives a beacon or a scan packet in the existing route, the node may set a priority route to a sink node that is reset, and transition to the active state.

It may be understood that a state of the node described above is changed by the scan packet, the route notification set packet rnsp, and the unset packet, each being transmitted from the sink node.

As such, the node has an advantage that with respect to a communication problem in a tag area network, a smooth communication state may be maintained.

The features, structures, effects, etc. described above in the embodiments are included in at least one embodiment of the present disclosure, but are not limited to only one embodiment. Further, the features, structures, effects, etc. described in the embodiments may also be combined or modified with respect to other embodiments by those of ordinary skill in the art to which the embodiments pertain. Therefore, contents related to such combinations and modifications should be construed as being included in the scope of the present disclosure.

In addition, the foregoing description has been made with reference to the embodiments, but it is merely illustrative and is not intended to limit the present disclosure. It will be apparent that other changes and applications can be made by those skilled in the art to which the present disclosure belong without departing from substantial features of the embodiments of the present disclosure. For example, each component specifically shown in the embodiments can be modified and implemented. And it should be construed that differences relating to such changes and applications are included in the scope of the present disclosure defined in the appended claims.

1. A low-power wireless network system comprising:
a manager node;
nodes configured to transmit data collected via a tag area network; and
a sink node which is a base station, selected by a command by the manager node, and configured to transmit the data transmitted from the nodes to the manager node,
wherein the sink node individually performs communication with the nodes and receives the data, on a basis of a wakeup interval configured for each of the nodes.

2. The low-power wireless network system of claim 1, wherein the wakeup interval is a transition interval of each of the nodes from a sleep state to a wakeup state in which communication may be performed.

3. The low-power wireless network system of claim 1, wherein, when first and second new nodes are installed in the tag area network, the manager node transmits, to the sink node, a scan command for checking installation of the first and second new nodes.

4. The low-power wireless network system of claim 3, wherein, when the scan command is received, the sink node transmits a scan packet corresponding to the scan command to the tag area network, and receives first and second route notification packets transmitted from the first and second new nodes, respectively, to check the installation of the first and second new nodes.

5. The low-power wireless network system of claim 4, wherein, when the scan packet is received, the first and second new nodes set priority routes to the sink node and transmit the first and second route notification packets to the sink node, respectively.

6. The low-power wireless network system of claim 4, wherein, when the installation of the first and second new nodes is checked, the sink node transmits, to the manager node, a request packet for requesting first and second identifications (IDs) of the first and second new nodes to set routes for communication in the tag area network.

7. The low-power wireless network system of claim 6, wherein, when the request packet is received and only a route of the first new node among the first and second new nodes is set in the tag area network, the manager node transmits, to the sink node, the first ID and a route set command to set the route of the first new node, and
the sink node sets and updates the first ID in a set route table according to the route set command, and transmits a route notification set packet to the first new node.

8. The low-power wireless network system of claim 7, wherein, when the route notification set packet is received, the first new node transmits, to the sink node, a first route set packet for the priority route to notify setting of the priority route.

9. The low-power wireless network system of claim 7, wherein, when the second new node does not receive the route notification set packet for a set time period, the second new node unsets the setting of the priority route.

10. The low-power wireless network system of claim 7, wherein, when the request packet is received and routes of the first and second new nodes are set in the tag area network, the manager node transmits, to the sink node, the first and second IDs and the route set command to set the routes of the first and second new nodes, and
the sink node sets and updates the first and second IDs in the set route table according to the route set command.

11. The low-power wireless network system of claim 10, wherein, when the route notification set packet is received, the first and second new nodes transmit, to the sink node, first and second route setting packets for the priority routes to notify setting of the priority routes, respectively.

12. The low-power wireless network system of claim 1, wherein, when a particular node among the nodes is unset from the tag area network, the manager server transmits a particular ID of the particular node and an unset command to the sink node to unset the particular node.

13. The low-power wireless network system of claim 12, wherein the sink node transmits an unset packet to the particular node according to the unset command, and unsets the particular ID from a route table in which IDs of the nodes are set.

14. The low-power wireless network system of claim 13, wherein, when the unsetting packet is received, the particular node deletes a priority route set in the tag area network, and transmits, to the tag area network, a route unset notification packet for notifying the unsetting.

15. The low-power wireless network system of claim 1, wherein a first node, among the nodes, transmits a first data packet comprising a first wakeup interval and the data to at least one of a sink node and a second node among the nodes.

16. The low-power wireless network system of claim 15, wherein the at least one of the second node and the sink node sets, in a set wakeup table, the first wakeup interval comprised in the first data packet, and transmits a second data packet to the first node according to the first wakeup interval.
